(19) United States
(12) Patent Application Publication
(10) Pub. No.: US 2018/0320642 A1
(43) Pub. Date: Nov. 8, 2018

(54) INTAKE AIR TEMPERATURE CONTROL DEVICE FOR ENGINE

(71) Applicant: AISAN KOGYO KABUSHIKI KAISHA, Obu-shi, Aichi (JP)

(72) Inventors: Fumihito NAKATANI, Obu-shi (JP); Takahiko IWAKURA, Aichi-gun (JP); Kazufumi ISHII, Kariya-shi (JP)

(73) Assignee: AISAN KOGYO KABUSHIKI KAISHA, Obu-shi, Aichi (JP)

(21) Appl. No.: 15/772,552

(22) PCT Filed: Nov. 30, 2016
(86) PCT No.: PCT/JP2016/085462

§ 371 Date: May 1, 2018

(30) Foreign Application Priority Data
Jan. 26, 2016 (JP) 2016-012686

(51) Int. Cl. F02M 31/04; F02P 5/04; F02M 31/06; F02D 41/00

(52) U.S. Cl. CPC F02M 31/042; F02P 5/045; F02M 31/06; F02D 2200/1002; F02D 2200/101; F02D 2200/0414; F02D 41/0002

(57) ABSTRACT

An ECU controls a passage switch valve according to the operation state of an engine, to control the temperature of intake air introduced into the engine, by selectively causing outside air from an outside air inlet, high-temperature air from a high-temperature passage, or mixed air comprising the outside air and the high-temperature air to flow towards the downstream side of an intake passage. The ECU calculates the MBT ignition timing and the knock limit ignition timing based on detection results of sensors, and controls the passage switch valve such that, when the knock limit ignition timing is at a more advanced angle than the MBT ignition timing, the high-temperature air or the mixed air is introduced into the engine, and when the knock limit ignition timing is the same as or at a more delayed angle than the MBT ignition timing, the outside air is introduced into the engine.

### TECHNICAL FIELD

The present invention relates to an intake air temperature control device for controlling a temperature of intake air which is introduced in an engine through an intake passage, and more particularly, to an intake air temperature control device for an engine configured to selectively let flow any one of unheated air which is not heated, heated air which has been heated, or mixed air of the heated air and the unheated air as the intake air to the engine.

### BACKGROUND ART

Patent Literature 1 has been known as one example of this type of technique. In this technique, an intake passage of an engine is branched off on its midway to two passages of an intake air heating passage and an intake air cooling passage. The intake passage is provided with an intake passage valve upstream of the two branched passages, and this valve is configured to set a flowing ratio of the intake air which is going to pass through the two passages. The intake air heating passage is provided with an intake air heating member to heat the intake air. The intake air cooling passage is provided with an intake air cooling member to cool down the intake air. Further, an electronic control unit (ECU) is provided to control the intake passage valve to adjust an intake air temperature of the mixed air constituted of the air having passed through the intake air heating passage and the air having passed through the intake air cooling passage. The engine is further provided with a knock sensor for detecting engine knocking. The ECU is configured to carry out a feedback control (closed-loop control) of the intake passage valve in a direction to prevent knocking in accordance with an output from the knock sensor. The ECU performs this feedback control because continuous flowing of the high-temperature air into the engine after completion of engine warm-up operation could cause a problem of engine knocking.

### RELATED ART DOCUMENTS

### Patent Documents

Patent Literature 1: JPH07(1995)-286562A

### SUMMARY OF INVENTION

### Technical Problem

According to the technique of Patent Literature 1, the intake passage valve is set in a direction to prevent knocking in accordance with the output from the knock sensor. However, the above control is the feedback control, and this may cause delay in control of the intake passage valve. Further, there is a possibility of causing errors in knocking detection due to any reason such as product variations in knock sensors. This variation in products might cause damages on the engine due to failure of preventing knocking or may result in deterioration in fuel efficiency of the engine due to delay (retardation) in ignition timing more than necessary for avoidance of knocking.

The present invention has been made in view of the above circumstances, and has a purpose of providing an intake air temperature control device for an engine which can achieve improvement in fuel efficiency and emission of the engine by introducing heated air or mixed air as intake air into the engine before completion of engine warm-up and further achieve prevention of knocking by predictively shutting off the heated air or the mixed air and introducing unheated air as the intake air into the engine after completion of the engine warm-up.

### Solution to Problem

(1) To achieve the above object, one aspect of the present invention provides an intake air temperature control device for an engine, comprising: an intake passage for introducing intake air into the engine; an unheated air passage for introducing unheated air which is free from heating into the intake passage; a heated air passage for introducing heated air which has been heated into the intake passage; a passage switch member for switching passages to selectively flow any one of the unheated air from the unheated air passage, the heated air from the heated air passage, and mixed air constituted of the unheated air and the heated air into a downstream side of the intake passage; and a control unit for controlling the passage switch member according to an operation state of the engine, the intake air temperature control device being configured to selectively flow any one of the unheated air, the heated air, and the mixed air constituted of the unheated air and the heated air to the downstream side of the intake passage to adjust the temperature of the intake air which is going to be introduced in the engine, wherein the intake air temperature control device further comprises: a fuel supply member for supplying fuel to the engine; an ignition member for igniting combustible gas mixture constituted of the fuel supplied to the engine and the intake air introduced in the engine; an intake property detection member for detecting property of the intake air which flows through the intake passage downstream of the passage switch member; a rotational speed detection member for detecting rotational speed of the engine; and a load detection member for detecting a load of the engine, and the control unit is configured to calculate MBT ignition timing at which engine torque becomes maximum and knock limit ignition timing which is immediately before occurrence of knocking of the engine based on detection results obtained by the intake property detection member, the rotational speed detection member, and the load detection member, and to control the passage switch valve to introduce any one of the heated air and the mixed air as intake air to the engine when the knock limit ignition timing is advanced more than the MBT ignition timing and introduce the unheated air as the intake air into the engine when the knock limit ignition timing is equal to or delayed from the MBT ignition timing.

According to the above configuration (1), the MBT ignition timing and the knock limit ignition timing are calculated based on the intake air property, the rotational speed of the engine, and the engine load. When the knock limit ignition timing is advanced more than the MBT ignition timing, the passage switch member is controlled so that the heated air or the mixed air is introduced into the engine as the intake air. Accordingly, in a region of the MBT ignition timing where the engine torque becomes maximum, the heated air or the mixed air is introduced in the engine, and thus atomization of combustible gas mixture is promoted. When the knock limit ignition timing is equal to or delayed from the MBT ignition timing, on the other hand, the passage switch member is controlled so that the heated air or the mixed air is shut off and instead the unheated air is introduced into the engine as the intake air. Namely, when the engine has been almost warmed up and the knock limit ignition timing becomes equal to or delayed from the MBT ignition timing, knocking is predicted and the unheated air is going to be introduced into the engine as the intake air instead of the heated air or the mixed air.

(2) To achieve the above object, in the configuration of the above (1), preferably, the passage switch member is a passage switch valve which is constituted of a motor-operated valve, the passage switch valve including a valve element and a motor for driving the valve element, and the valve element is arranged switchable between a first position for introducing only the unheated air into the intake passage and a second position for introducing only the heated air into the intake passage and arranged to be held in any midway position between the first position and the second position; the intake property detection member includes an intake air temperature sensor for detecting an intake air temperature as property of the intake air; and the control unit is configured to control the passage switch valve so that the intake air temperature detected by the intake air temperature sensor reaches a target intake air temperature when the knock limit ignition timing is advanced more than the MBT ignition timing.

According to the above configuration (2), in addition to an operation of the above configuration (1), the passage switch valve is controlled when the knock limit ignition timing is advanced more than the MBT ignition timing, and thus the temperature of the intake air which is introduced in the engine is set to a predetermined target intake air temperature. This makes it possible to adjust the intake air temperature to the most appropriate one for driving the engine.

### Advantageous Effects of Invention

According to the above configuration (1), before completion of the engine warm-up, the heated air or the mixed air is introduced in the engine, thus achieving improvement in fuel efficiency and emission of the engine, and after completion of the engine warm-up, flow of the heated air or the mixed air is predictively shut off and the unheated air is introduced into the engine as the intake air, thus achieving avoidance of the engine knocking.

According to the above configuration (2), in addition to the effect of the above configuration (1), the mixed air as the intake air at the most appropriate temperature is introduced into the engine before completion of the engine warm-up, thus further improving the fuel efficiency and the emission of the engine.

### BRIEF DESCRIPTION OF DRAWINGS

FIG. 1 is a schematic configurational view of a gasoline engine system in a first embodiment;

FIG. 2 is a graph showing a relationship of fuel efficiency of an engine and an intake air temperature in the first embodiment;

FIG. 3 is a flowchart showing a process of intake air temperature control in the first embodiment;

FIG. 4 is a graph showing respective ignition timing maps correlated to a relationship between engine load and ignition timing;

FIG. 5 is a time chart indicating each behavior of (a) automobile speed, (b) an intake air temperature, (c) knock limit ignition timing and MBT ignition timing, and (d) switching of a passage switch valve between an outside air position (OFF) and a high-temperature air position (ON);

FIG. 6 is a flowchart showing a process of intake air temperature control in a second embodiment;

FIG. 7 is a graph showing an image of ignition timing correction by use of a temperature correction coefficient in the second embodiment; and

FIG. 8 is a graph showing a relationship between an opening degree of the passage switch valve and the intake air temperature in the second embodiment.

### DESCRIPTION OF EMBODIMENTS

### First Embodiment

A first embodiment embodying an intake air temperature control device for an engine of the present invention is now explained in detail below with reference to the accompanying drawings.

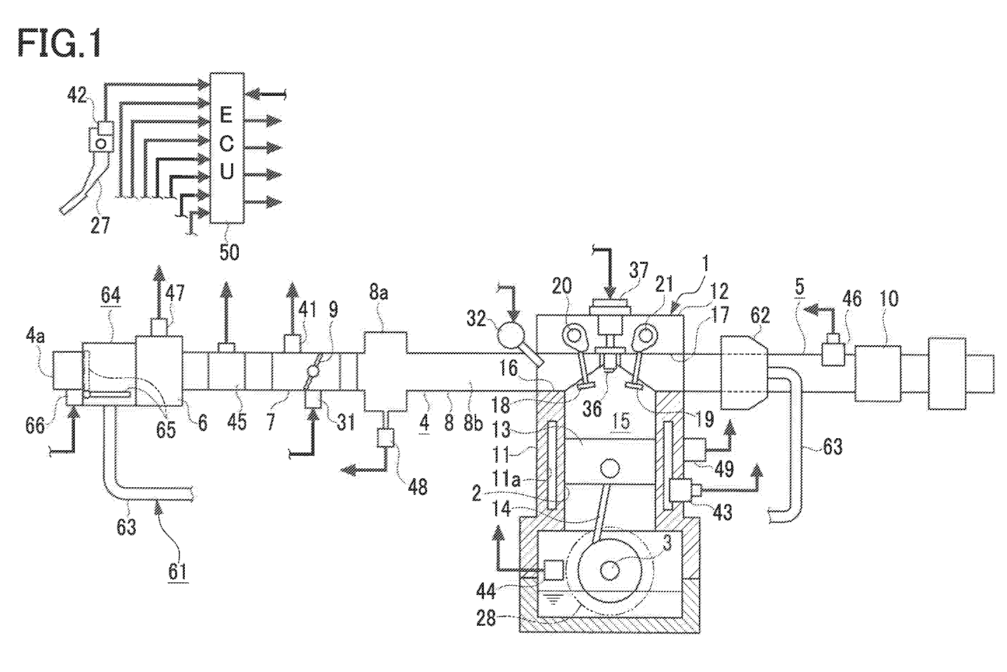

FIG. 1 is a schematic configurational view of a gasoline engine system of the subject embodiment. In this embodiment, an engine 1 mounted in an automobile is a four-stroke cycle reciprocal engine and includes four cylinders 2 and a crank shaft 3. The engine 1 is provided with an intake passage 4 to introduce intake air into the engine 1 and an exhaust passage 5 to discharge exhaust air out of the engine 1. The intake passage 4 is provided with an air cleaner 6, an electronic throttle device 7, and an intake manifold 8 in this order from an upstream side of the passage. The electronic throttle device 7 includes a butterfly-type throttle valve 9 configured to open or close by driving a motor 31 and a throttle sensor 41 for detecting an opening degree (a throttle opening degree) TA of the throttle valve 9. The intake manifold 8 includes a surge tank 8a and four branch passages 8b each branching off from the surge tank 8a to extend to each cylinder 2 of the engine 1. The exhaust passage 5 is provided with a catalyst converter 10 to purify the exhaust air flowing through the passage 5.

The engine 1 includes a cylinder block 11 and a cylinder head 12. The cylinder block 11 encompasses the cylinders 2, and each cylinder 2 is provided with a piston 13. Each piston 13 is coupled with the crank shaft 3 via a connecting rod 14. Each cylinder 2 includes a combustion chamber 15. The combustion chamber 15 is formed between the piston 13 and the cylinder head 12 via each cylinder 2. The cylinder head 12 is provided with intake ports 16 and exhaust ports 17 each communicating with the combustion chamber 15 of the cylinder 2. The respective intake ports 16 are communicated with the intake passage 4 (the intake manifold 8). The respective exhaust ports 17 are communicated with the exhaust passage 5 (an exhaust manifold). Each intake port 16 is provided with an intake valve 18, and each exhaust port 17 is provided with an exhaust valve 19. The respective intake valves 18 and the respective exhaust valves 19 are operated to open or close by the valve operating mechanism including cam shafts 20 and 21 in association with rotation of the crank shaft 3, namely, in association with an up and down movement of the respective pistons 13 or in association with a series of working stroke (intake stroke, compression stroke, explosion stroke, and exhaust stroke) of the engine 1. The intake valves 18 are operated to open or close by the cam shafts 20 on an intake side, and the exhaust valves 19 are operated to open or close by the cam shafts 21 on an exhaust side.

The cylinder head 12 is provided with injectors 32 each corresponding to each of the cylinders 2 to inject fuel into the respective intake ports 16. Each injector 32 is configured to inject the fuel which is supplied from a fuel supply device (not shown) and corresponds to one example of a fuel supply member of the present invention. In each combustion chamber 15, combustible gas mixture is formed of the fuel injected through the injector 32 and the air (intake air) taken from the intake manifold 8.

The cylinder head 12 is provided with ignition plugs 36 each corresponding to each of the cylinders 2. The ignition plugs 36 are configured to make spark operation upon receipt of ignition signal output from ignition coils 37. Both the components 36 and 37 constitute an ignition unit to ignite the combustible gas mixture in each of the combustion chambers 15. The ignition unit corresponds to one example of an ignition member of the present invention. The combustible gas mixture in each of the combustion chambers 15 is made to explode and burn by the spark operation of the respective ignition plugs 36 in the compression stroke, and then the explosion stroke proceeds. Exhaust air after burning is discharged outside through each combustion chamber 15, each exhaust port 17, the exhaust passage 5, and the catalyst converter 10 in the exhaust stroke. In association with this operation including burning of the combustible gas mixture in the combustion chambers 15, the up and down movement of each piston 13 promotes a series of operating process to rotate the crank shaft 3, thus applying motive power to the engine 1.

In the present embodiment, an intake air temperature control device 61 is provided as an attachment device of the engine 1 to selectively switch the intake air to be introduced in each combustion chamber 15 of the engine 1 from any one of the outside air, the high-temperature air, and the mixed air of the outside air and the high-temperature air. The outside air corresponds to one example of unheated air which is not heated of the present invention. Further, the high-temperature air corresponds to one example of heated air which has been heated of the present invention. In the present embodiment, the heated air heated around the exhaust passage 5 (an exhaust manifold) near the cylinder head 12 is used as the high-temperature air. The device 61 is provided with a funnel-shaped shroud 62 to collect the high-temperature air, a high-temperature air passage 63 to introduce the high-temperature air collected by the shroud 62 into the intake passage 4 upstream of the air cleaner 6, and a passage switch valve 64 provided in the intake passage 4 upstream of the air cleaner 6. The passage switch valve 64 corresponds to one example of a passage switch member of the present invention. On a leading end of the intake passage 4, an outside air inlet 4a for taking in the outside air is provided. To the passage switch valve 64, a leading end of the high-temperature air passage 63 is connected. The high-temperature air passage 63 corresponds to one example of a heated air passage of the present invention, and the intake passage 4 upstream of the passage switch valve 64 corresponds to one example of an unheated air passage of the present invention. The most-leading end of the intake passage 4 is the outside air inlet 4a. In the present embodiment, the exhaust passage 5 (the exhaust manifold) in the vicinity of the cylinder head 12 takes a role of heating measure, and the high-temperature air which has been heated in this exhaust passage 5 is made to flow through the high-temperature air passage 63. The passage switch valve 64 constituted as a motor-operated valve is provided with a valve element 65 and a motor 66 for operating the valve element 65. The valve element 65 is provided in a switchable manner in any position of an outside air position indicated with a solid line in FIG. 1 and a high-temperature air position indicated with a double-dashed line in FIG. 1. The valve element 65 is further allowed to be held in any midway position between the outside air position and the high-temperature air position. When the valve element 65 is placed in the outside air position, flow of the high-temperature air from the high-temperature air passage 63 is shut off, and the outside air from the outside air inlet 4a is introduced in the air cleaner 6 (introduction of outside air). On the other hand, when the valve element 65 is placed in the high-temperature air position, the outside air from the outside air inlet 4a is shut off, and the high-temperature air from the high-temperature air passage 63 is introduced in the air cleaner 6 (introduction of high-temperature air). Further, when the valve element 65 is positioned in a midway position, the outside air from the outside air inlet 4a and the high-temperature air from the high-temperature air passage 63 are mixed at a predetermined ratio and introduced in the air cleaner 6 as the mixed air (introduction of mixed air). Herein, the outside air position corresponds to one example of a first position of the present invention, and the high-temperature air position corresponds to one example of a second position of the present invention.

During introduction of the high-temperature air, the intake air temperature control device 61 achieves promotion of warm-up of the intake passage 4 including the intake manifold 8 and thus improves fuel efficiency and emission of the engine 1, thereby preventing generation of condensed water in the intake passage 4. During introduction of the outside air, on the other hand, the device 61 achieves decrease in a temperature of the intake air which is introduced in each of the combustion chambers 15, thus improving filling efficiency of the intake air. Further, decrease in the intake air temperature leads to decrease in a compressed end temperature, thus contributing to prevention of the engine 1 knocking. During introduction of the mixed air, it is possible to adjust the intake air temperature to the most appropriate temperature according to an operation state of the engine 1.

As shown in FIG. 1, respective sensors 41 to 49 provided in the engine 1 constitute an operating state detection member to detect the operation state of the engine 1. An accelerator pedal 27 provided in a driver's seat is provided with an accelerator sensor 42. The accelerator sensor 42 detects a pressed angle representing an operation amount of the accelerator pedal 27 as an accelerator opening degree ACC and outputs an electric signal according to the detected value. A water temperature sensor 43 provided in the engine 1 detects a temperature of cooling water (a coolant temperature) THW flowing through a water jacket 11a or the like formed in the cylinder block 11 and outputs an electric signal according to the thus detected value. A rotational speed sensor 44 provided in the engine 1 detects a rotational speed (an engine rotational speed) NE of the crank shaft 3 and outputs an electric signal according to the detected value. This sensor 44 specifically detects rotation of a timing rotor 28, which has one end fixed to the crank shaft 3, at every predetermined angle. The rotational speed sensor 44 corresponds to one example of a rotational speed detection member of the present invention. An air flow meter 45 provided in the intake passage 4 upstream of the electronic throttle device 7 detects an intake amount Ga of the intake air flowing through the intake passage 4 and outputs an electric signal according to the detected value. An oxygen sensor 46 provided in the exhaust passage 5 detects an oxygen concentration (output voltage) Ox in the exhaust air which is discharged to the exhaust passage 5 and outputs an electric signal according to the detected value. An intake air temperature sensor 47 provided in the air cleaner 6 detects an intake air temperature THA in the intake passage 4 downstream of the passage switch valve 64 and outputs an electric signal according to the detected value. The intake air temperature sensor 47 corresponds to one example of an intake property detection member of the present invention. An intake pressure sensor 48 provided in the surge tank 8a detects an intake pressure PM in the intake passage 4 downstream of the electronic throttle device 7 and outputs an electric signal according to the detected value. The rotational speed sensor 44 and the air flow meter 45 correspond to one example of a load detection member of the present invention. A knock sensor 49 provided in the cylinder block 11 detects vibration generated by knocking of the engine 1 and outputs an electric signal according to the detected value.

This engine system is provided with an electronic control unit (ECU) 50 to control operation of the engine 1. The sensors 41 to 19 are connected to the ECU 50. Further, the ECU 50 is connected to the motor 31 of the electronic throttle device 7, the injectors 32, the ignition coils 37, and a motor 66 of the passage switch valve 64. The ECU 50 corresponds to one example of a control unit of the present invention.

In the present embodiment, the ECU 50 is configured to control the motor 31, the injectors 32, the ignition coils 37, and the motor 66 so that fuel injection control, ignition timing control, knock control, intake air temperature control, and others are carried out based on output signals from the respective sensors 41 to 49.

As well known, the ECU 50 includes a central processing unit (CPU), various memories, an external input circuit, an external output circuit, and others. The memory is stored with predetermined control program related to each control of the engine 1. The CPU is configured to carry out each control operation based on a predetermined control program upon receipt of detection signals which are input from the sensors 41 to 49 through the input circuit.

The fuel injection control includes regulating a fuel injection amount and adjusting injection timing of the injectors 32 according to the operation state of the engine 1. The ignition timing control includes adjusting the ignition timing of the ignition plugs 36 by controlling the ignition coils 37 according to the operation state of the engine 1. The knocking control includes adjusting the ignition timing of the ignition plugs 36 by controlling the ignition coils 37 based on the value detected by the knock sensor 49 so that knocking of the engine 1 is prevented.

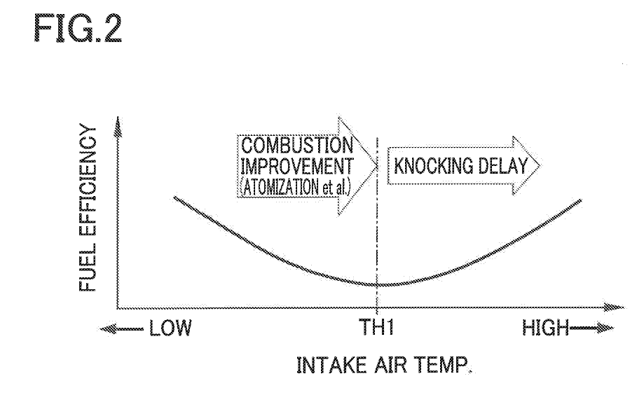

The intake air temperature control includes regulating the passage switch valve 64 according to the operation state of the engine 1 so that any one of the outside air from the outside air inlet 4a, the high-temperature air from the high-temperature air passage 63, and the mixed air of the outside air and the high-temperature air is selectively let flow to the downstream side of the intake passage 4 and then introduced in the combustion chambers 15 of the engine 1. The intake air temperature of the intake air introduced in the combustion chambers 15 is thus set according to the operation state of the engine 1. FIG. 2 is a graph indicating a relationship of the fuel efficiency of the engine 1 with respect to the intake air temperature. As shown in FIG. 2, the fuel efficiency of the engine 1 decreases curvedly as the intake air temperature increases from a low temperature to a predetermined intermediate temperature TH1, and the fuel efficiency increases curvedly as the intake air temperature increases from the predetermined temperature TH1 to the higher temperature. In an area where the intake temperature is lower than the predetermined temperature TH1, fuel combustion of the combustible gas mixture is promoted by atomization of the fuel. In an area where the intake temperature is higher than the predetermined temperature TH1, knocking of the engine 1 tends to be easily occurred.

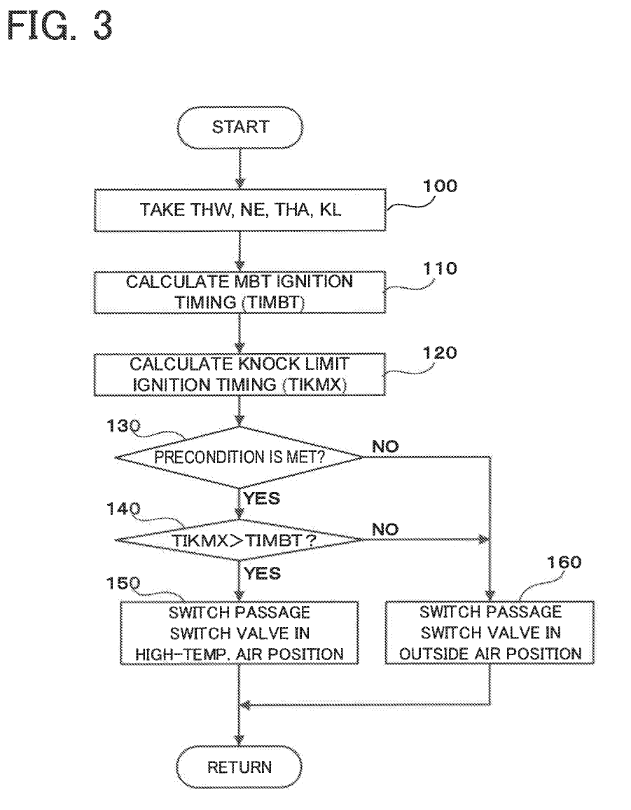

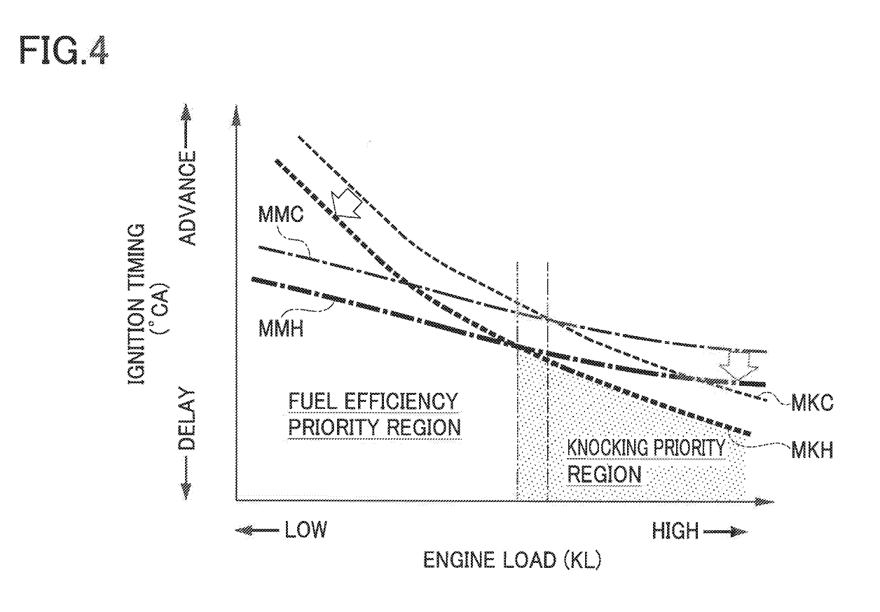

The intake air temperature control of the present embodiment is now explained in detail. FIG. 3 is a flowchart indicating a process of the intake air temperature control. FIG. 4 is a graph showing respective ignition timing maps MMC, MMH, MKC, and MKH correlated to a relationship between engine load KL and the ignition timing. The ECU 50 initiates processing a routine of FIG. 3 concurrently with start of the engine 1.

When a process proceeds to this routine, in a step 100, the ECU 50 takes the coolant temperature THW, the engine rotational speed NE, the intake air temperature THA, and the engine load KL from the detection results obtained by the water temperature sensor 43, the rotational speed sensor 44, the air flow meter 45, and the intake temperature sensor 47, respectively. The ECU 50 obtains the engine load KL from a relation of the engine rotational speed NE and the intake air amount Ga.

In a step 110, the ECU 50 calculates MBT (Minimum Spark Advance for Best Torque) ignition timing TIMBT at which the torque of the engine 1 becomes maximum. The ECU 50 can calculate the MBT ignition timing TIMBT from the obtained engine rotational speed NE and the engine load KL with reference to a predetermined MBT ignition timing map. The ECU 50 has an outside air map MMC (see FIG. 4) for introducing the outside air and a high-temperature air map MMH (see FIG. 4) for introducing the high-temperature air as the predetermined MBT ignition timing map. The ECU 50 selects one of these maps MMC and MMH in each of introduction of the outside air and introduction of the high-temperature air to calculate the MBT ignition timing TIMBT. The ECU 50 can determine the map to be used from the two maps MMC and MMH by referring to the obtained intake air temperature THA.

In a step 120, the ECU 50 calculates knock limit ignition timing TIKMX which is the timing immediately before occurrence of knocking in the engine 1. The ECU 50 can calculate the knock limit ignition timing TIKMX from the obtained engine rotational speed NE and the engine load KL by referring to a predetermined knock limit ignition timing map. As the predetermined knock limit ignition timing map, the ECU 50 has an outside air map MKC (see FIG. 4) for introducing the outside air and a high-temperature air map MKH (see FIG. 4) for introducing the high-temperature air. The ECU 50 selects one of these maps MKC and MKH in each of introduction of the outside air and introduction of the high-temperature air and then calculates the knock limit ignition timing TIKMX. The ECU 50 determines the map to be used from the two maps MKC and MKH by referring to the obtained intake air temperature THA.

In a step 130, the ECU 50 determines whether a precondition for the intake air temperature control is met. Specifically, the ECU 50 determines an establishment of the precondition such as conditions of “the coolant temperature being equal to or more than a predetermined value (warm-up of the engine 1 having completed),” “introduction of the outside air having continued for a predetermined term or more,” and “no knocking having been occurred.” The ECU 50 proceeds with the process to a step 140 when this determination result is affirmative and proceeds with the process to a step 160 when the determination result is negative.

In the step 140, the ECU 50 determines whether the calculated knock limit ignition timing TIKMX is advanced more than the calculated MBT ignition timing TIMBT. The ECU 50 proceeds with the process to a step 150 when this determination result is affirmative, and when the determination result is negative, the ECU 50 proceeds with the process to the step 160.

In the step 150, the ECU 50 controls the valve element 65 of the passage switch valve 64 to be in the high-temperature position and then returns the process to the step 100. Thus, the combustion chambers 15 of the engine 1 are introduced with the high-temperature air as the intake air.

On the other hand, in the step 160 proceeding from the step 130 or the step 140, the ECU 150 controls the valve element 65 of the passage switch valve 64 to be in the outside air position and returns the process to the step 100. The combustion chambers 15 of the engine 1 are thus introduced with the outside air as the intake air at a relatively low temperature.

According to the above control operation, the ECU 50 calculates the MBT ignition timing TIMBT and the knock limit ignition timing TIKMX based on the detection results obtained by the intake air temperature sensor 47, the rotational speed sensor 44, and the intake pressure sensor 48. Subsequently, the ECU 50 controls the passage switch valve 64 so that the high-temperature air as the intake air is introduced into the engine 1 when the knock limit ignition timing TIKMX is advanced more than the MBT ignition timing TIMBT, and controls the passage switch valve 64 so that the outside air as the intake air is introduced into the engine 1 when the knock limit ignition timing TIKMX is equal to or delayed from the MBT ignition timing TIMBT.

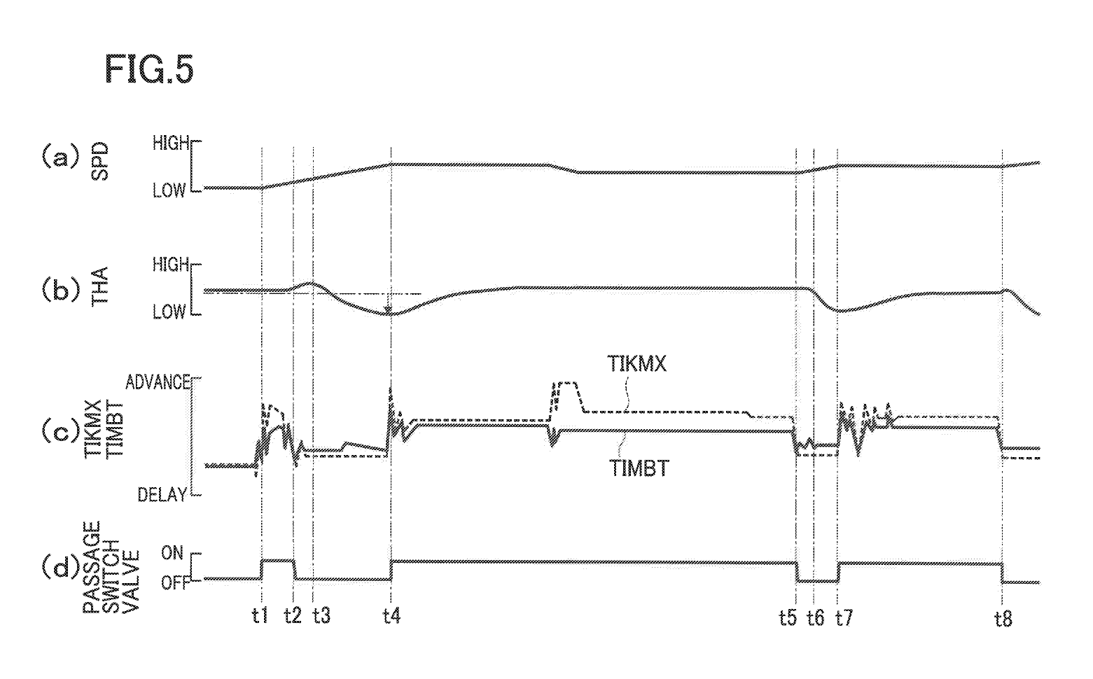

FIG. 5 is a time chart showing each behavior of (a) vehicle speed SPD of an automobile, (b) the intake air temperature THA, (c) the knock limit ignition timing TIKMX and the MBT ignition timing TIMBT, and (d) switching of the outside air position (OFF) and the high-temperature air position (ON) of the passage switch valve 64. In FIG. 5, specifically, the vehicle speed SPD starts to increase at a time t1, and thus the engine 1 is accelerated. The knock limit ignition timing TIKMX is accordingly advanced more than the MBT ignition timing TIMBT, so that the passage switch valve 64 is switched to be in the high-temperature position (ON). Subsequently, the knock limit ignition timing TIKMX becomes equal to the MBT ignition timing TIMBT at a time t2, and thus the passage switch valve 64 is switched to the outside air position (OFF). As a result, the intake air temperature THA that has once begun to increase starts to decrease at a time t3. At a subsequent time t4 when the intake air temperature THA has decreased to a certain degree, the knock limit ignition timing TIKMX is advanced more than the MBT ignition timing TIMBT, thus switching the passage switch valve 64 from the outside air position (OFF) to the high-temperature air position (ON). As a result, the intake air temperature THA starts to increase. After that, each of the knock limit ignition timing TIKMX and the MBT ignition timing TIMBT varies according to changes in the vehicle speed SPD, but the knock limit ignition timing TIKMX continues to be advanced more than the MBT ignition timing TIMBT, and thus the passage switch valve 64 is held in the high-temperature position (ON). The knock limit ignition timing TIKMX becomes then equal to the MBT ignition timing TIMBT at a time t5, and the passage switch valve 64 is switched from the high-temperature position (ON) to the outside air position (OFF). This switching causes start of decrease in the intake air temperature THA at a time t6. At a subsequent time t7, the knock limit ignition timing TIKMX becomes advanced more than the MBT ignition timing TIMBT, and accordingly, the passage switch valve 64 is switched from the outside air position (OFF) to the high-temperature air position (ON), resulting in increase of the intake air temperature THA again. The knock limit ignition timing TIKMX subsequently becomes equal to the MBT ignition timing TIMBT at a time t8, and then the passage switch valve 64 is switched from the high-temperature air position (ON) to the outside air position (OFF) again. As a result, the intake air temperature begins to decrease. When the intake air temperature THA is made to be relatively high due to an advanced state of the knock limit ignition timing TIKMX advanced more than the MBT ignition timing TIMBT, the intake air is switched to the outside air in order to lower the intake air temperature THA. Therefore, it is prevented to continuously introduce the high-temperature air as the intake air into the combustion chambers 15 after completion of warm-up of the engine 1, further preventing occurrence of knocking beforehand.

According to the above-explained intake air temperature control device for the engine of the present embodiment, the MBT ignition timing TIMBT and the knock limit ignition timing TIKMX are calculated based on the intake air temperature THA, the engine rotational speed NE, and the engine load KL. When the knock limit ignition timing TIKMX is advanced more than the MBT ignition timing TIMBT, the passage switch valve 64 is operated such that the high-temperature air or the mixed air is introduced in the combustion chambers 15 of the engine 1 as the intake air. Accordingly, in a region of the MBT ignition timing TIMBT where the torque of the engine 1 is maximum, the high-temperature air or the mixed air is introduced in the engine 1, thus promoting atomization of the combustible gas mixture. As a result, the fuel efficiency and emission of the engine 1 are improved. On the other hand, when the knock limit ignition timing TIKMX is equal to or delayed from the MBT ignition timing TIMBT, the passage switch valve 64 is set to shut off the high-temperature air or the mixed air and instead introduce the outside air as the intake air into the combustion chambers 15 of the engine 1. Specifically, the passage switch valve 64 is switched to the outside air position by a feedforward control in prediction of knocking. Accordingly, when the engine 1 has been almost warmed up and the knock limit ignition timing TIKMX is equal to or delayed from the MBT ignition timing TIMBT, knocking is predicted and the outside air is introduced as the intake air into the combustion chambers 15 instead of the high-temperature air or the mixed air. It is therefore possible to prevent knocking after completion of the engine 1 warm-up. The present embodiment thus achieves improvement in the fuel efficiency and the emission of the engine 1 before completion of the engine 1 warm-up by introducing the high-temperature air or the mixed air into the engine 1, and further achieves prevention of knocking of the engine 1 after completion of the engine 1 warm-up by predictively shutting off the high-temperature air or the mixed air and instead introducing the outside air to the engine 1 as the intake air.

In the present embodiment, occurrence of knocking is predicted during introduction of the high-temperature air or the mixed air into the engine 1 in advance of detecting knocking by the knock sensor 49, and the passage switch valve 64 is switched to the outside air position according to the operation state of the engine 1 to introduce the outside air. Therefore, knocking of the engine 1 can be prevented without relying on the knock sensor 49 irrespective of presence or absence of detection error in the knock sensor 49.

### Second Embodiment

A second embodiment embodying an intake air temperature control device for an engine according to the present invention is explained in detail with reference to the accompanying drawings.

In the following explanation, similar or identical parts or components of those of the above-mentioned first embodiment are assigned with the same reference signs as those in the first embodiment and their explanations are omitted, and thus the following explanation is made with a focus on the differences from the first embodiment.

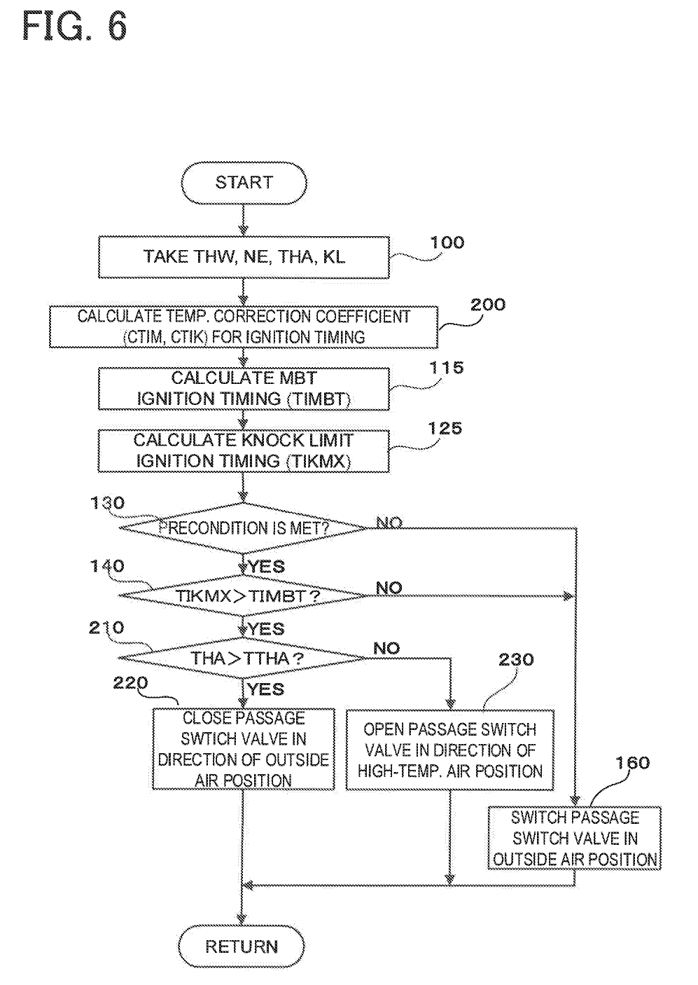

The present embodiment is different from the first embodiment in a process of the intake air temperature control. FIG. 6 is a flowchart indicating the process of the intake air temperature control. The flowchart of FIG. 6 includes steps 115 and 125 which are different from the steps 110 and 120 in the flowchart of FIG. 3. The flowchart of FIG. 6 is further different from that of FIG. 3 in a manner that a step 200 is provided between the step 100 and the step 115 and that steps 210 to 230 are provided instead of the step 150 after the step 140.

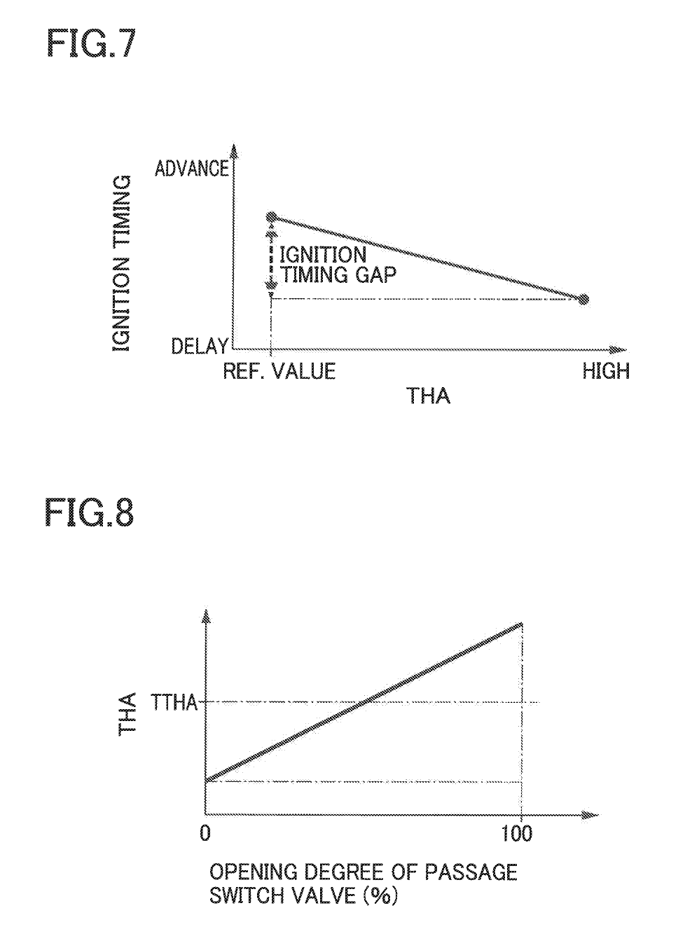

When the process proceeds to a routine shown in FIG. 6, the ECU 50 carries out the process in the step 100 and then calculates temperature correction coefficients CTIM and CTIK of the ignition timing in the step 200. The temperature correction coefficient CTIM is a coefficient for correcting the MBT ignition timing TIMBT which will be explained later, and the temperature correction coefficient CTIK is a coefficient for correcting the knock limit ignition timing TIKMX which will be explained later. The ECU 50 obtains the temperature correction coefficients CTIM and CTIK by referring to predetermined maps, for example. FIG. 7 is a graph showing an image of ignition timing correction by use of these temperature correction coefficients CTIM and CTIK. As shown in FIG. 7, correction of the ignition timing by use of the temperature correction coefficients CTIM and CTIK leads to delay in the ignition timing according to increase in the intake air temperature THA increasing from a predetermined reference value.

In a step 115, the ECU 50 calculates the MBT ignition timing TIMBT. The ECU 50 calculates reference ignition timing from the obtained engine rotational speed NE and the engine load KL by referring to a predetermined MBT ignition timing map (see FIG. 4). The MBT ignition timing TIMBT is then obtained by multiplying the reference ignition timing by the temperature correction coefficient CTIM.

In a step 125, the ECU 50 calculates the knock limit ignition timing TIKMX. The ECU 50 calculates the reference ignition timing from the obtained engine rotational speed NE and the engine load KL by referring to a predetermined knock limit ignition timing map (see FIG. 4). The knock limit ignition timing TIKMX is then obtained by multiplying the reference ignition timing by the temperature correction coefficient CTIK.

Subsequently, the ECU 50 carries out the process of the steps 130 and 140, and when the determination result of the step 140 is affirmative, the process proceeds to the step 210. In the step 210, the ECU 50 determines whether the intake air temperature THA is higher than a target intake air temperature TTHA. When a determination result in the step 210 is affirmative, the ECU 50 proceeds with the process to the step 220. When the determination result is negative, the process proceeds to the step 230.

In the step 220, the ECU 50 controls the passage switch valve 64 to close in a direction of the outside air position (0%). FIG. 8 is a graph showing a relation between an opening degree of the passage switch valve 64 and the intake air temperature THA. In FIG. 8, an opening degree “0%” of the passage switch valve 64 represents a state in which the valve element 65 is placed in the outside air position, and the opening degree “100%” represents a state in which the valve element 65 is placed in the high-temperature air position. When the intake temperature THA is higher than the target intake temperature TTHA, therefore, the passage switch valve 64 is closed to have an opening degree smaller than the instant opening degree (closed in a direction closer to the outside air position) so that the intake temperature THA approaches the target intake temperature TTHA. Subsequently, the ECU 50 returns the process to the step 100.

In the step 230, on the other hand, the ECU 50 controls the passage switch valve 64 to open in a direction of the high-temperature air position (100%). Accordingly, when the intake temperature THA is lower than the target intake temperature TTHA, the passage switch valve 64 is made to open at an opening degree larger than the instant opening degree (in a direction closer to the high-temperature air position) so that the intake temperature THA approaches the target intake temperature TTHA. Subsequently, the ECU 50 returns the process to the step 100.

According to the above control, when the knock limit ignition timing TIKMX is advanced more than the MBT ignition timing TIMBT, the ECU 50 is made to control the passage switch valve 64 so that the intake temperature THA detected by the intake temperature sensor 47 becomes equal to the predetermined target intake temperature TTHA.

According to the intake air temperature control device for the engine in the above-explained embodiment, the following operation and effect can be achieved in addition to those of the first embodiment. To be specific, when the knock limit ignition timing TIKMX is advanced more than the MBT ignition timing TIMBT, the passage switch valve 64 is controlled so that the intake air temperature THA of the intake air to be introduced in the engine 1 is adjusted to the predetermined target intake temperature TTHA. The intake temperature THA can be thus adjusted to the most appropriate temperature for operation of the engine 1. This contributes to further improvement of the fuel efficiency and the emission of the engine 1 than the first embodiment by the introduction of the mixed air at the most appropriate temperature into the engine 1 as the intake air before completion of warm-up of the engine 1.

The present invention is not limited to the above embodiments and may be applied with partial modification in its configuration without departing from the scope of the invention.

In the above embodiments, the intake air temperature sensor 47 is provided to detect the intake air temperature as intake property, but alternatively, an intake air humidity sensor to detect intake air humidity as the intake property may be provided.

### INDUSTRIAL APPLICABILITY

The present invention is utilized to adjust a temperature of intake air which is to be introduced in a gasoline engine or a diesel engine.

### REFERENCE SIGNS LIST

1 Engine
4 Intake passage
8 Intake manifold
32 Injectors (Fuel supply member)
36 Ignition plugs (Ignition member)
37 Ignition coils (Ignition member)
44 Rotational speed sensor (Rotational speed detection member, Load detection member)
45 Air flow meter (Load detection member)
47 Intake air temperature sensor (Intake property detection member)
50 ECU (Control unit)
63 High-temperature air passage (Heated air passage)
64 Passage switch valve (Passage switching member)
65 Valve element
66 Motor

1. An intake air temperature control device for an engine, comprising:
an intake passage for introducing intake air into the engine;
an unheated air passage for introducing unheated air which is free from heating into the intake passage;
a heated air passage for introducing heated air which has been heated into the intake passage;
a passage switch member for switching passages to selectively flow any one of the unheated air from the unheated air passage, the heated air from the heated air passage, and mixed air constituted of the unheated air and the heated air into a downstream side of the intake passage; and
a control unit for controlling the passage switch member according to an operation state of the engine,
the intake air temperature control device being configured to selectively flow any one of the unheated air, the heated air, and the mixed air constituted of the unheated air and the heated air to the downstream side of the intake passage to adjust the temperature of the intake air which is going to be introduced in the engine, wherein
the intake air temperature control device further comprises:
a fuel supply member for supplying fuel to the engine;
an ignition member for igniting combustible gas mixture constituted of the fuel supplied to the engine and the intake air introduced in the engine;
an intake property detection member for detecting property of the intake air which flows through the intake passage downstream of the passage switch member;
a rotational speed detection member for detecting rotational speed of the engine; and
a load detection member for detecting a load of the engine, and
the control unit is configured to calculate MBT ignition timing at which engine torque becomes maximum and knock limit ignition timing which is immediately before occurrence of knocking of the engine based on detection results obtained by the intake property detection member, the rotational speed detection member, and the load detection member, and to control the passage switch valve to introduce any one of the heated air and the mixed air as intake air to the engine when the knock limit ignition timing is advanced more than the MBT ignition timing and introduce the unheated air as the intake air into the engine when the knock limit ignition timing is equal to or delayed from the MBT ignition timing.

2. The intake air temperature control device for the engine according to claim 1, wherein
the passage switch member is a passage switch valve which is constituted of a motor-operated valve, the passage switch valve including a valve element and a motor for driving the valve element, and the valve element is arranged switchable between a first position for introducing only the unheated air into the intake passage and a second position for introducing only the heated air into the intake passage and arranged to be held in any midway position between the first position and the second position;
the intake property detection member includes an intake air temperature sensor for detecting an intake air temperature as property of the intake air; and
the control unit is configured to control the passage switch valve so that the intake air temperature detected by the intake air temperature sensor reaches a target intake air temperature when the knock limit ignition timing is advanced more than the MBT ignition timing.
